(19) United States
(12) Patent Application Publication
(10) Pub. No.: US 2021/0051932 A1
(43) Pub. Date: Feb. 25, 2021

(54) Fishing appliance with photoluminescent accent and methods

(71) Applicant: Flow Tek, Inc., Boulder, CO (US)

(72) Inventor: Robert H. Goodale, Boulder, CO (US)

(73) Assignee: Flow Tek, Inc., Boulder, CO (US)

(21) Appl. No.: 16/602,181

(22) Filed: Aug. 23, 2019

(51) Int. Cl. A01K 85/01; A01K 83/00; A01K 85/08

(52) U.S. Cl. CPC A01K 85/01; A01K 85/08; A01K 83/00

(57) ABSTRACT

Fishing appliances and methods characterized by use of a photoluminescent accent are disclosed. The fishing appliances include a hook or other structure with an eye portion and hook portion. A photoluminescent or iridescent material accent is adhered to a segment of the exterior arc of the crook of the hook portion.

### FIELD OF THE INVENTION

This invention relates to sport fishing hooks and artificial bait and, more particularly, relates to fishing appliances utilizing photoluminescent applications.

### BACKGROUND OF THE INVENTION

Use of attractants in association with sport fishing flies and lures is well known. In particular, the use of photoluminescent and iridescent materials in association with such artificial baits has been heretofore suggested and/or utilized (see U.S. Pat. Nos. 3,935,659, 5,490,344, 6,684,557, 8,567,109, 4,638,584, and 3,936,970, for example) with differing degrees of success.

Field utilization of such materials has called into question the efficacy of such applications however. It is felt that overuse or over-application of such materials may actually prove less effective. Moreover, lack of care for location of such materials in association the artificial baits is also now felt to be critical, known applications being on the body of the lure or fly tying materials such as hackle, yarn, feathers, synthetic wing fibers, skins, or the like on flies. Such overuse and haphazard placement of photoluminescent and/or iridescent materials needs further consideration. No such applications have heretofore been suggested for use with fishing hooks themselves. Improvements therein could thus still be utilized.

### SUMMARY OF THE INVENTION

This invention provides a fishing appliance with selectively applied photoluminescent accent and methods of production thereof. The appliance and methods correct overuse and haphazard placement of photoluminescent materials in association with artificial baits as heretofore utilized, and can be associated with the hook alone.

The fishing appliance of this invention includes a line engageble structure (for example, a fishing hook, and fishing fly, a fishing lure, or other artificial bate) that an eye portion and a hook portion. The hook portion is characterized by a crook (its curved portion) adjacent a terminus of the hook portion. A photoluminescent material accent is adhered to a selected and typically small segment of the crook of the hook portion of the structure.

The methods of this invention for production of a fishing appliance including a line engageble eye portion and a hook portion having a crook adjacent a terminus thereof include mixing of a water based directly-to-metal acrylic paint with a selected photoluminescent or iridescent pigment to provide an accent mixture. The accent mixture is applied the accent mixture to a selected segment of the crook of the hook portion and allowed to fully dry. The appliance and accent are heated in an oven at about 121° C. for a selected time period (usually about 15 minutes).

It is therefore an object of this invention to provide a fishing appliance with selectively applied photoluminescent accent.

It is another object of this invention to provide a method of production of a fishing appliance with a photoluminescent accent.

It is still another object of this invention to provide a fishing appliance and method that corrects the overuse and haphazard placement of photoluminescent materials in association with artificial baits as heretofore utilized.

It is yet another object of this invention to provide a fishing hook with selectively applied photoluminescent accent.

It is another object of this invention to provide a fishing appliance that includes a line engageble structure including an eye portion and a hook portion, the hook portion including a crook adjacent a terminus of the hook portion, and a photoluminescent material accent adhered to a segment of the crook of the hook portion of the structure.

It is still another object of this invention to provide a fishing appliance that includes a hook having a line engageable eye at one end thereof and a crook adjacent a terminus thereof and a photoluminescent accent adhered to a segment of the crook of the hook.

It is yet another object of this invention to provide methods for production of a fishing appliance including a line engageble eye portion and a hook portion having a crook adjacent a terminus thereof, the methods including mixing a water based directly-to-metal acrylic paint with a selected photoluminescent or iridescent pigment to provide an accent mixture, applying the accent mixture to a selected segment of the crook of the hook portion of the fishing appliance, allowing the applied accent mixture to dry, and heating the appliance in an oven at about 121° C. for a selected time period.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1A to 1C are perspective views showing various exemplary fishing appliances (hooks, flies, lures and the like) utilizing the accent of this invention;

FIG. 2 is a top perspective view of the appliance of FIG. 1A;

FIG. 3 is a side view of the appliance of FIG. 1A;

FIG. 4 is a sectional view of the appliance of this invention; and

FIG. 5 is another sectional view of the appliance of this invention.

### DESCRIPTION OF THE INVENTION

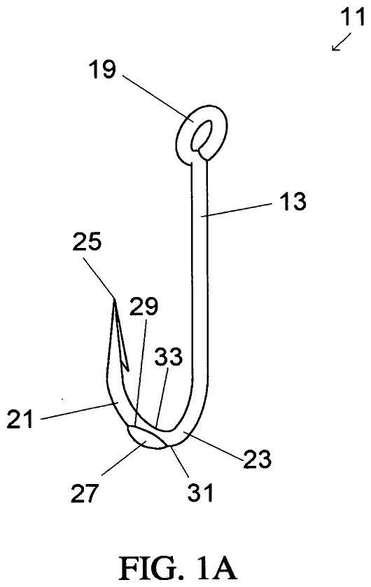

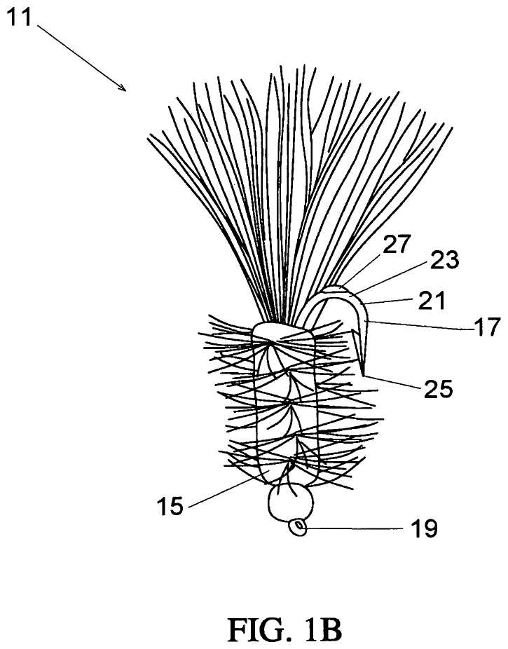

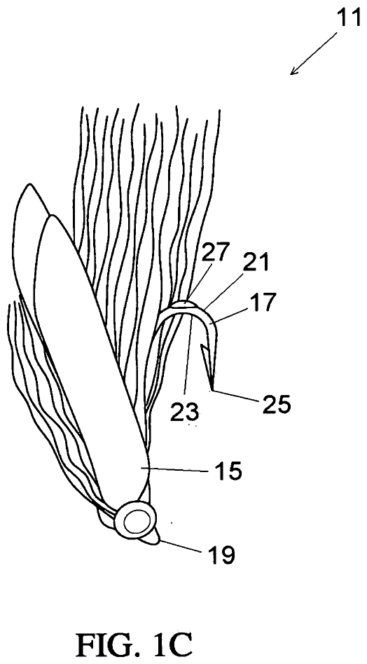

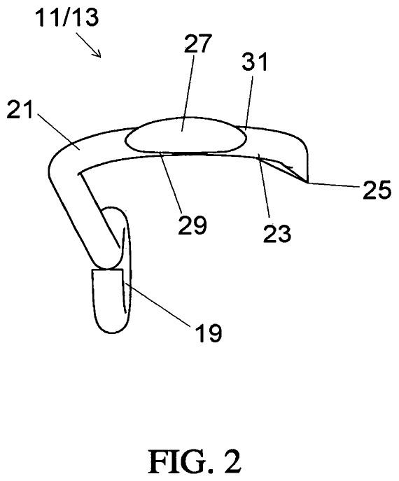

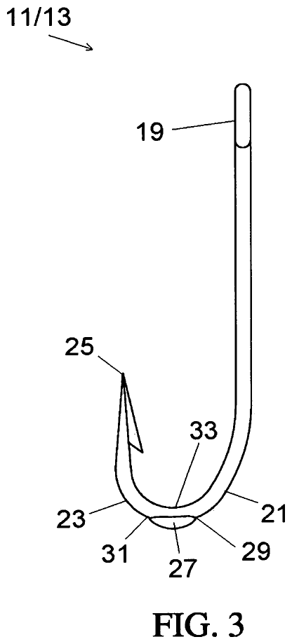

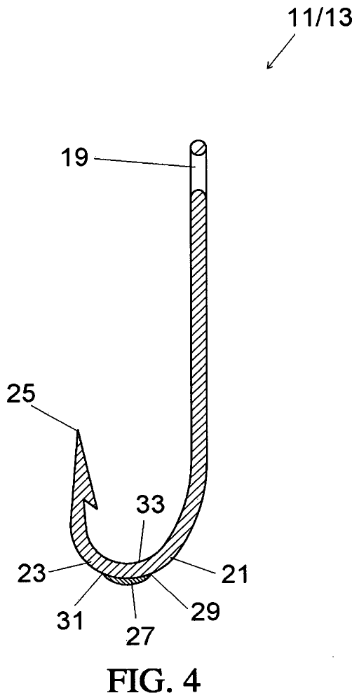

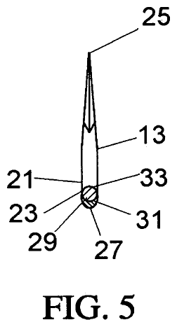

The fishing appliances and methods of this invention are shown and described with reference to FIGS. 1 through 7. Various iterations of appliances 11 such as those shown in FIGS. 1A through 1C include fishing hooks 13 (FIG. 1A), fishing flies 15 as shown in FIGS. 1B and 1C, and fishing lures and other hook based artificial baits. In all cases of artificial baits, a fishing hook establishes the basis of the artificial baits. Hook 13 or line engageble structures 17 of the artificial baits include line engageable eye portion 19 and hook portion 21. Hook portion 21 is characterized by crook 23 (the curved part of the hook) adjacent terminus 25 of hook portion 21. Photoluminescent material accent 27 is adhered to segment 29 of crook 23 of hook portion 21 of hook/structure 13/17 at crook exterior arc 31 thereof facing exterior hook portion 21 and opposite crook interior arc 33 facing interior hook portion 21.

Photoluminescent material accent 27 is made by mixing photoluminescent (preferably) or iridescent pigment with acrylic paint. For example water based direct to metal (DTM) acrylic paint (for example, BENJAMIN MOORE SUPER SPEC water base DTM acrylic paint) is mixed with the selected pigment (75% paint to 25% pigment, for example). The pigments used may be any of numerous known phosphorescent or fluorescent materials (for example the various Glow in the Dark pigments form Dorum Color Co.). Photoluminescent powder pigments, such as aluminate based (strontium aluminate, for example) pigments or sulfide based pigments are readily adaptable to this application. The selected pigments are preferably waterproof and compatibly mixable with the selected acrylic paint. Other iridescent or photoluminescent paints and pigments could be utilized.

Once mixed, a dot of the mixture is adhered to segment 29 on outer arc 31 of crook 23 of hook portion 21 (though the dot may in some cases be applied both to the inner and outer arc of the crook of the hook) thus providing the accent. The adhering process includes application of the mixture to the segment and, once fully dried (about an hour dry time is suggested), placing the hook/structure in an oven at about 121° C. for approximately 15 minutes. Once cooled, the hooks can be used alone with bait, as the basis for tied flies, or with a lure or other artificial baits.

As may be appreciated from the foregoing, improved photoluminescent fishing appliances and methods are provided that can be adapted for use with any artificial baits or fishing hooks. While application of a photoluminescent accent is shown performed prior to artificial bait formation, the methods of this invention can be adapted for application after formation of the fly, lure or other artificial bait.

What is claimed is:

1. A fishing appliance comprising:
a line engageble structure including an eye portion and a hook portion, said hook portion including a crook adjacent a terminus of said hook portion; and
a photoluminescent material accent adhered to a segment of said crook of said hook portion of said structure.

2. The fishing appliance of claim 1 wherein said crook of said hook portion of said line engageable structure has an arc facing interior said hook portion and an arc facing exterior said hook portion, said accent adhered primarily at said arc facing exterior.

3. The fishing appliance of claim 1 wherein said accent is formed of a mixture of water based directly-to-metal acrylic paint and a phosphorescent or fluorescent material pigment.

4. The fishing appliance of claim 1 wherein said accent is formed of a mixture of directly-to-metal acrylic paint and strontium aluminate based pigment.

5. The fishing appliance of claim 1 further comprising a fly pattern portion formed at said line engageable structure and associated with said eye portion and said hook portion.

6. The fishing appliance of claim 1 wherein said line engageable structure includes a fishing lure body portion associated with said eye portion and said hook portion.

7. A fishing appliance comprising:
a hook having a line engageable eye at one end thereof and a crook adjacent a terminus thereof; and
a photoluminescent accent adhered to a segment of said crook of said hook.

8. The fishing appliance of claim 7 wherein said photoluminescent accent includes a phosphorescent or fluorescent material.

9. The fishing appliance of claim 7 wherein said photoluminescent accent includes sulfide or aluminate based pigment.

10. The fishing appliance of claim 7 wherein said photoluminescent accent includes a strontium aluminate based pigment.

11. The fishing appliance of claim 7 further comprising a fly pattern portion at said hook.

12. The fishing appliance of claim 7 further comprising a fishing lure body portion associated with said hook

13. A method for production of a fishing appliance including a line engageble eye portion and a hook portion having a crook adjacent a terminus thereof, said method comprising the steps of:
mixing a directly-to-metal acrylic paint with a selected photoluminescent or iridescent pigment to provide an accent mixture;
applying the accent mixture to a selected segment of the crook of the hook portion of the fishing appliance;
allowing the applied accent mixture to dry; and
heating the appliance in an oven at about 121° C. for a selected time period.

14. The method of claim 13 wherein the step of mixing paint with pigment includes utilizing a phosphorescent or fluorescent material pigment.

15. The method of claim 13 wherein the step of mixing paint with pigment includes utilizing sulfide or aluminate based pigment.

16. The method of claim 13 wherein the step of mixing paint with pigment includes utilizing strontium aluminate based pigment.

17. The method of claim 13 wherein the step of mixing paint with pigment includes mixing 75% water based paint with 25% pigment, and wherein the selected time period is about 15 minutes.

18. The method of claim 13 wherein the eye portion and hook portion define a fishing hook, the method further comprising the step of forming a fly pattern on the hook.

19. The method of claim 13 wherein the eye portion and hook portion define a fishing hook, the method further comprising the step of attaching the hook to a lure body.

20. The method of claim 13 wherein the eye portion and hook portion define a fishing hook.
